(19) United States
(12) Patent Application Publication
(10) Pub. No.: US 2007/0271175 A1
(43) Pub. Date: Nov. 22, 2007

(54) System, method and apparatus for brokering loan applications

(76) Inventor: Dennis Shaden, Tierra Verde, FL (US)

Correspondence Address: LARSON AND LARSON, 11199 69TH STREET NORTH, LARGO, FL, 33773, US

(21) Appl. No.: 11/435,419

(22) Filed: May 17, 2006

(51) Int. Cl. G06Q 40/00

(52) U.S. Cl. 705/38

(57) ABSTRACT

A loan brokering system for providing loan program information to brokers includes a server computer with a processor, a memory and a network interface, the network interface operatively coupling the server computer to a network. The system also includes a loan database coupled to the server computer; a lender interface operating on the server computer for accepting the loan program information and for storing the loan program information in the loan database; and a broker interface operating on the server computer adapted to input borrower information, search the loan database and display loan programs applicable to the borrower information

### BACKGROUND OF THE INVENTION

1. Field of the Invention

This invention relates to the field of brokering loan applications and more particularly to a system and method for communicating up-to-date loan availability between lenders and loan brokers.

2. Description of the Related Art

The process of finding the best loan for a given set of circumstances is often very difficult. There are countless lenders, each having several loan programs and each loan program having many different options, making it difficult to find a good fit loan. Furthermore, one is never sure that the located loan program is the best one available.

In many scenarios, a borrower visits a broker and discloses information related to what they need including a description of the property, the amount they need to borrow, payment desires and personal information such as social security numbers. The broker (or loan agent) then searches for a loan program that matches the borrower's needs and credit scores. Currently, the broker may have access to various loan programs delivered on paper or by email, or the broker may access each individual lender's information system (login) and see if any of that lender's programs meet the borrower's needs. This process is tedious, time consuming and doesn't provide immediate feedback to the borrower. Often, this part of the process is completed after the borrower leaves the broker's office, presenting the opportunity for the borrower to visit competing brokers.

Prior attempts at solving this problem fall short of providing an immediate loan program to the borrower. For example, US Patent Application 2006/0004651 to Corr, et al. describes a loan application tool, but it does not provide a consolidated list of loan programs available from multiple lenders. Instead, it has a step of “Contact Loan Officer” (328 of FIG. 3b) that requires a loan officer to be contacted (e.g., email or phone) and a set of reminders are established to remind the broker/loan agent to make sure a response is received from the loan officer.

Another attempt at solving this problem is described in US Patent Application 2005/0278249 to Jones, et al. The described method captures the loan information from the borrower (step 1300) but then distributes that information to a plurality of lenders (step 1302) then looks for approvals from the plurality of lenders (step 1304), presenting the approval(s), if any, to the borrower. The broker has no insight into what loan programs are available from different lenders so the entire lender information package must be sent to each qualified lender causing each qualified lender to review the loan request and determine if any of their current programs work for that borrower. This method also requires the broker to divulge the lender's information to a plurality of lenders before determining if those lenders have any programs that are even close to the borrower's criteria.

Another attempt at solving this problem is described in US Patent Application 2005/0187860 to Peterson, et al. The described method captures the loan information from an online borrower (steps 202, 204, 206). Later, the borrower's credit score is obtained and a list of lenders willing to lend to a borrower with that score is established (steps 234, 236, 238 and 240) then, the borrower's loan information is iteratively sent to each lender on the list (steps 246-258), waiting up to 24 hours (step 250) for each lender to respond. In this method, the broker has no insight into what loan programs are available from different lenders so the entire lender information package must be sent to each qualified lender causing each qualified lender to review the loan request and determine if any of their current programs work for that borrower, waiting up to 24 hours for each lender to respond. This method also requires the broker to divulge the lender's information to a plurality of lenders before determining if those lenders have any programs that are even close to the borrower's criteria.

Another attempt at solving this problem is described in US Patent Application 2004/0078296 to Dykes, et al, and is hereby incorporated by reference. The described method collects and disseminates loan information from lenders and stores it on a server. The server then takes a borrower's loan criteria and the loan data from the lenders to develop a list of adjustments to the points, cap or margin which is then presented to the broker or borrower. The described methods do not provide views of the basic loan programs (only an adjusted loan offer with adjusted points, cap and/or margin) and do not facilitate a connection between the broker and the lender to solidify a loan offer.

What is needed is a system and method that will capture loan programs from a plurality of lenders, capture information regarding a borrower, filter the loan programs based on the borrower information, present loan programs that meet the criteria of the borrower and provide access to the associated lender(s) for completing the loan application.

### SUMMARY OF THE INVENTION

One objective of the present invention is to provide a system in which lenders can describe available loan programs and in which brokers can specify borrower criteria and find any applicable loan programs meeting the borrower's criteria.

Another objective of the present invention is to provide a system in which lenders can describe available loan programs and in which brokers can enter borrower criteria and find any applicable loan programs meeting the borrower's criteria, then selecting an applicable loan, the broker can “direct apply” to the lender, speeding up the loan brokering process.

Another objective of the present invention is to provide a system in which lenders can describe available loan programs and in which brokers can enter borrower criteria and a geographic location (e.g., county) and find any applicable loan programs meeting the borrower's criteria. The geographic location allows the broker to select lenders with representatives local to the broker or local to the borrower's property.

In one embodiment, a loan brokering system for providing loan program information to brokers is disclosed including a server computer with a processor, a memory and a network interface, the network interface operatively coupling the server computer to a network. The system also includes a loan database operatively coupled to the server computer; a lender interface operating on the server computer for accepting the loan program information and for storing the loan program information in the loan database; and a broker interface operating on the server computer adapted to input borrower information, search the loan database and display loan programs applicable to the borrower information.

In another embodiment, a method for providing loan program information to loan brokers is disclosed including inputting loan program information for at least one loan program; storing the loan program information into a loan database; obtaining a borrower's loan criteria from a broker; searching the loan database for at least one loan program matching the borrower's loan criteria; selecting a qualified loan from the at least one loan program matching the borrower's loan criteria; and presenting the qualified loan to the borrower.

In another embodiment, a computer based method for providing loan program information to loan brokers is disclosed including presenting a user interface for inputting loan program information for at least one loan program; storing the loan program information into a loan database; presenting a second user interface for obtaining a borrower's loan criteria from a broker; searching the loan database for at least one loan program matching the borrower's loan criteria; and presenting a summary user interface for selecting a qualified loan from the at least one loan program matching the borrower's loan criteria.

In another embodiment, a computer readable medium including computer programming instructions that cause a computer to perform the method for providing loan program information to loan brokers is disclosed including presenting a user interface for inputting loan program information for at least one loan program; storing the loan program information into a loan database; presenting a second user interface for obtaining a borrower's loan criteria from a broker; searching the loan database for at least one loan program matching the borrower's loan criteria; and presenting a summary user interface for selecting a qualified loan from the at least one loan program matching the borrower's loan criteria.

In another embodiment, a computer program product for use with a computer system for providing loan program information to loan brokers is disclosed, the computer program product including a computer usable medium having computer-readable code embodied in the medium, the computer-readable code having computer readable code for presenting a user interface for inputting loan program information for at least one loan program; computer readable code for storing the loan program information into a loan database; computer readable code for presenting a second user interface for obtaining a borrower's loan criteria from a broker; computer readable code for searching the loan database for at least one loan program matching the borrower's loan criteria; and computer readable code means for presenting a summary user interface for selecting a qualified loan from the at least one loan program matching the borrower's loan criteria.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a typical top level broker user interface of a first embodiment of the present invention.

FIG. 2 illustrates a typical second level broker user interface of the first embodiment of the present invention.

FIG. 3 illustrates a typical third level broker user interface of the first embodiment of the present invention.

FIG. 4 illustrates a typical lender information user interface of the first embodiment of the present invention.

FIG. 5 illustrates a typical lender program creation user interface of the first embodiment of the present invention.

FIG. 6 illustrates a typical lender summary user interface of the first embodiment of the present invention.

FIG. 7 illustrates a flow chart for adding a new lender of the first embodiment of the present invention.

FIG. 8 illustrates a flow chart for the lender to add a new loan program of the first embodiment of the present invention.

FIG. 9 illustrates a flow chart for the broker to search for a loan for a borrower of the first embodiment of the present invention.

FIG. 10 illustrates a flow chart for the broker to complete the loan process for the borrower of the first embodiment of the present invention.

FIG. 11 illustrates a data connection diagram the first embodiment of the present invention.

FIG. 12 illustrates a typical computer system the first embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The user interface described is an example of a user interface for the loan brokering system. As these are exemplary, many other user interfaces are possible without veering from the present invention.

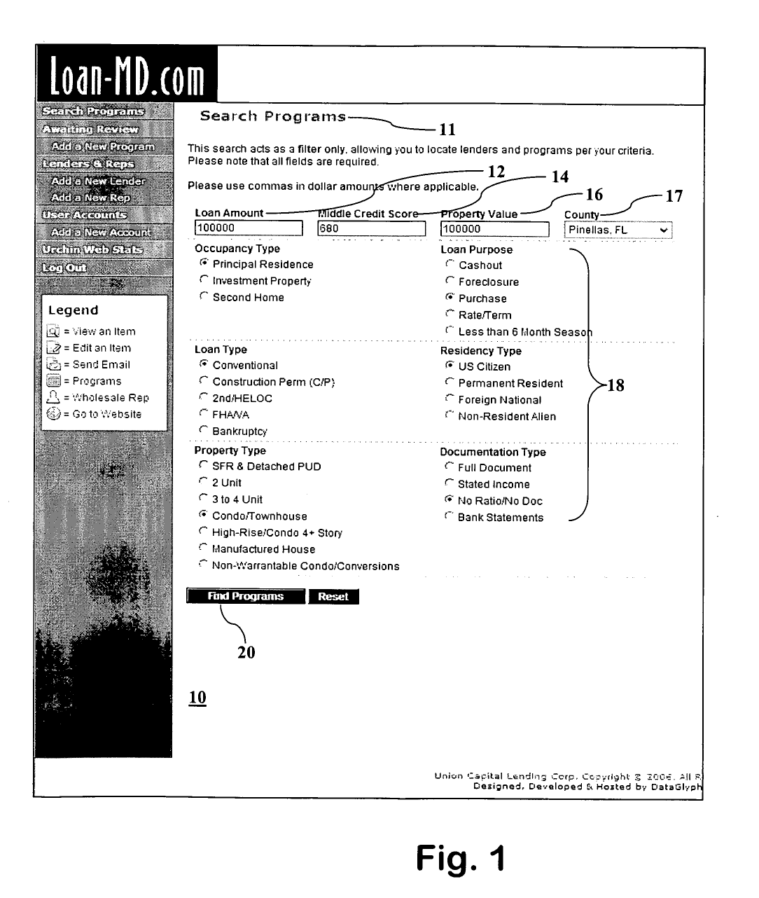

Referring to FIG. 1, a typical top level broker user interface 10 of a first embodiment of the present invention is shown. This is the loan program search screen 11. In such, the broker enters the borrower's data or loan criteria including the loan amount 12, the borrower's middle credit score 14, the value of the property 16 and a geographic location 17. The geographic location is selectable by the broker to be, for example, the location of the property, the residence of the borrower or the location of the broker, thereby finding lenders with representatives local to the property, borrower or broker, respectively.

The broker then selects the Occupancy Type, Loan Type, Loan Purpose, Residency Type, Property Type and Documentation Type 18 corresponding to the borrower and property. Once all data is entered, the broker selects the “Find Program” button 20 to find any loan programs that meet the borrower's criteria.

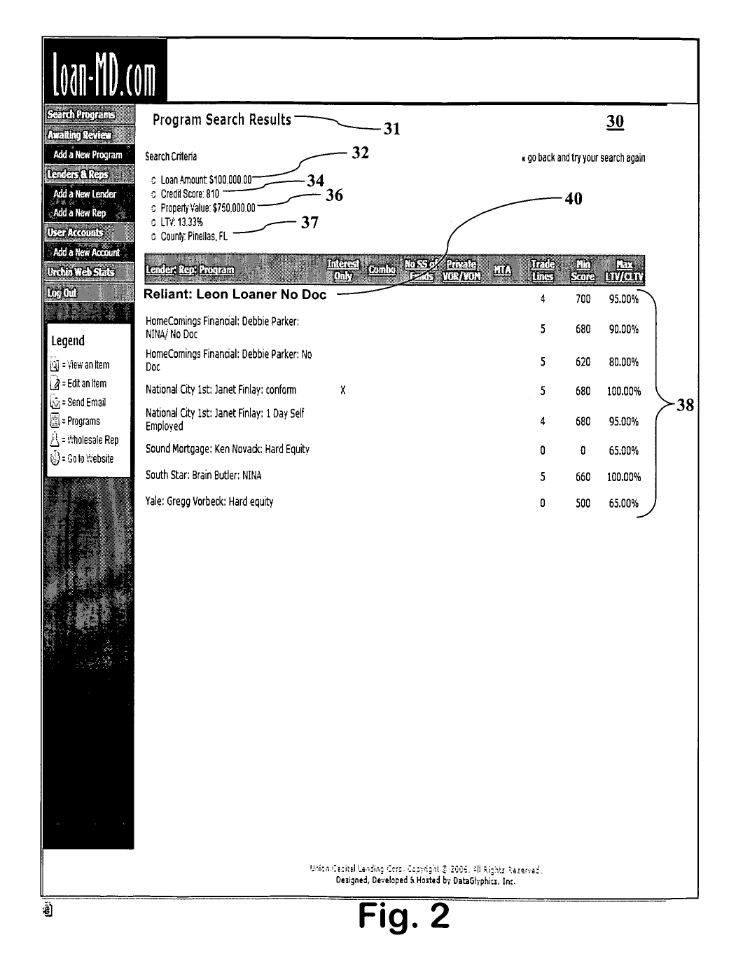

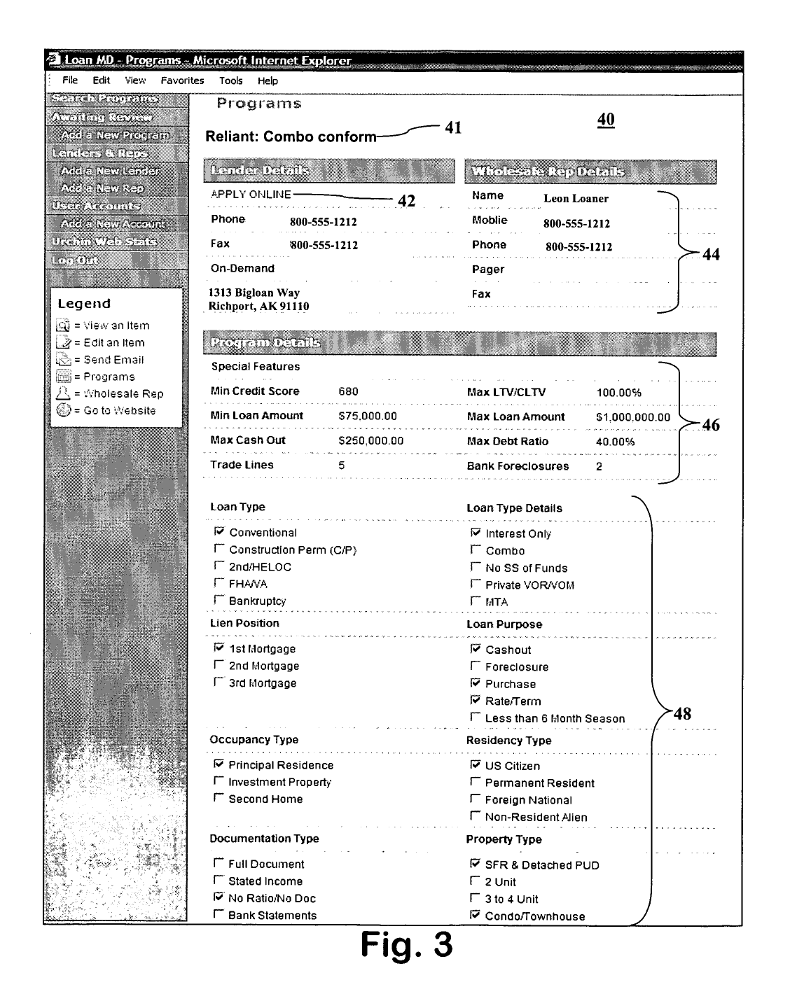

Referring to FIG. 2, a typical second level broker user interface 30 of the first embodiment of the present invention is shown. The Program Search Result screen 31 shows a summary of all loan programs available based on the borrower's information entered in the Search Programs screen 10. Some of the borrower's information is repeated for clarity, including the loan amount 32, credit score 34, property value 36 and geographic location 37. A list of available loan programs 38 is presented, one of which is from a company called Reliant which has a loan officer identified as Leon Loaner and offers a “No Doc” (no documentation required) loan 40. By selecting this loan program, the broker accesses a program detail screen as shown in FIG. 3.

Referring to FIG. 3, a typical third level broker user interface 40 of the first embodiment of the present invention is shown. This interface shows details regarding the selected loan program 41 including phone number and other contact information 44 to reach the loan companies representative and, if available, an apply online selector 42, which will take the broker through a logon-page of the lender's web site where they can log onto the lender's web site and complete an application for the borrower (not shown since lender's have many different formats for accepting loan applications). The detail page 40 includes detail information about the loan program such as minimum credit score, minimum loan amount, maximum cash-out, number of trade lines, maximum loan-to-value, maximum debt ratio and number of bank foreclosures 44. There is also a list of features for the loan such as loan type, lien position, occupancy type, documentation type, loan type details, loan purpose, residency type and property type 48.

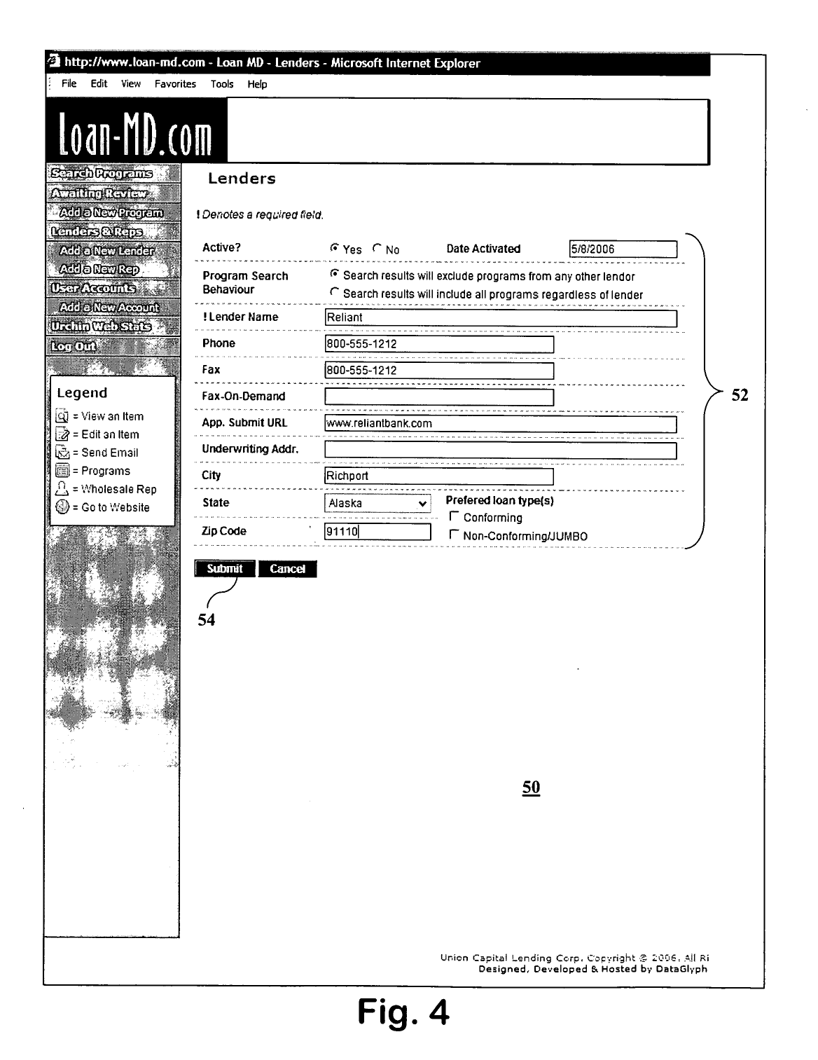

Referring to FIG. 4, a typical lender information user interface 50 of the first embodiment of the present invention is shown. This is the screen where the lender company name, phone numbers and address are entered 52. Additionally, a lender Application Submit URL is included 52 in which the URL of the lender's loan application web site is entered. This is the web address to which the broker is redirected if the select Apply Online 42. Once all information is entered, the submit button is selected 54 and the data is saved.

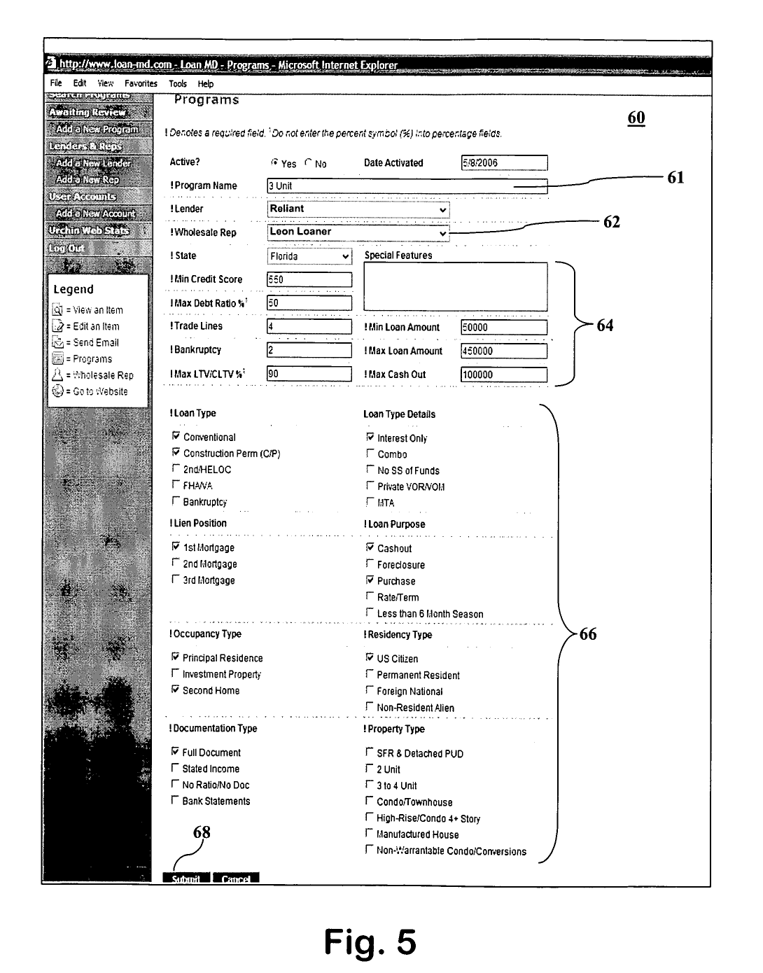

Referring to FIG. 5, a typical lender program creation user interface 60 of the first embodiment of the present invention is shown. The lender (or their representative) logs onto the system of the present invention and enters information regarding one or more loan programs they want to offer the users (brokers) of the system. In this example, the program name (3-unit) 61 is entered and the lender's representative (Leon Loaner) 62. The lender specifies the minimum credit score, minimum loan amount, maximum loan amount, maximum cash-out, number of trade lines, maximum loan-to-value, maximum debt ratio and number of bankruptcies 64. The lender also specifies the Occupancy Type, Loan Type, Loan Type Details, Loan Purpose, Lien Type, Residency Type, Property Type and Documentation Type 66. Once all data is entered, the lender selects the submit button 68 and the loan program is made live for all brokers to find from a search.

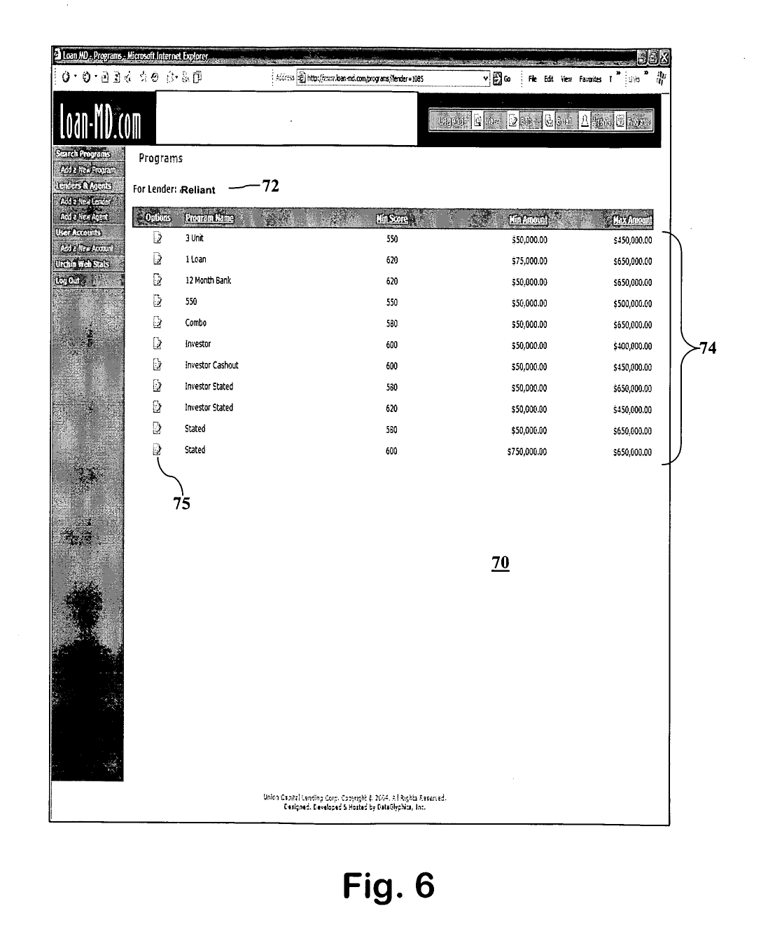

Referring to FIG. 6, a typical lender summary user interface 70 of the first embodiment of the present invention is shown. This page shows all loan programs currently being advertised to the brokers using the loan brokering system (e.g., loan brokers) by a specific lender 72 (Reliant in this example). This page displays one or more loan programs 74, including the “3 Unit” loan program described in FIG. 5. By clicking on the info icon 75, the lender can review details of their programs (as shown in FIG. 5) and make any changes needed.

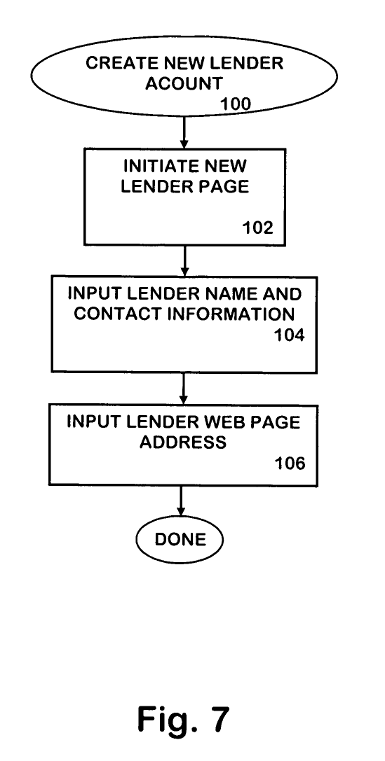

Referring to FIG. 7, a flow chart for adding a new lender of the first embodiment of the present invention is shown. To create an account for a new lender 100, an authorized user initiates a new lender page 102, inputs the lender name, contact information and a password 104, then adds the web page address (URL) 106 for access to the lender's web site for directly applying for one of the loan programs that have been found by a broker using the system of the present invention. Note that each broker may need to be a registered user of each lender's online loan application system.

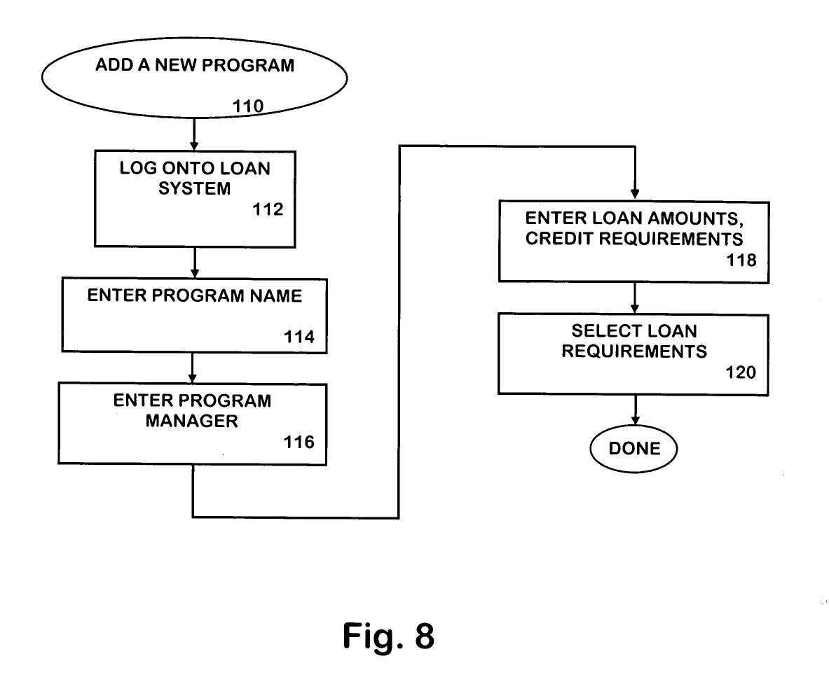

Referring to FIG. 8, a flow chart for the lender to add a new loan program of the first embodiment of the present invention is shown. To add a new loan program 110, the lender or their surrogate logs onto the loan system of the present invention 112 and inputs data regarding the loan program including the program name 114, the loan program manager 116, loan amounts, credit requirements, etc. 118 (as described above) and loan requirement selections 120 (as described above).

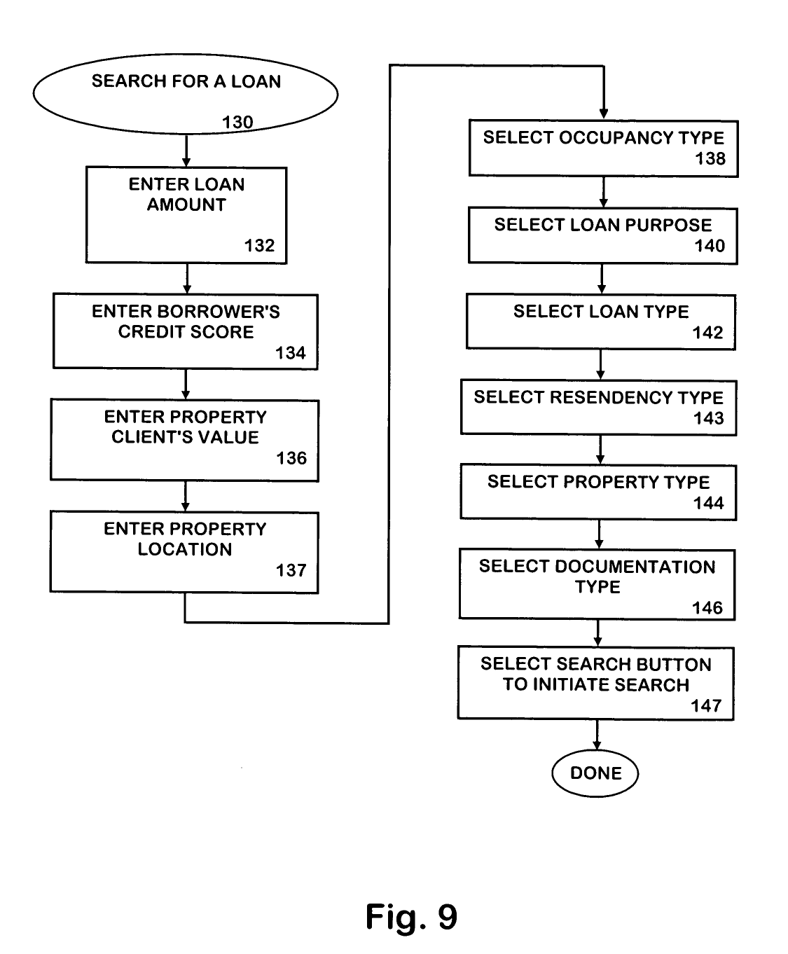

Referring to FIG. 9, a flow chart for the broker to search for a loan for a borrower of the first embodiment of the present invention is shown. To search for a loan 130, the broker enters a loan amount 132, the borrower's credit score 134, the property value 136, the geographic location 137, the occupancy type 138, the loan purpose 140, the loan type 142, the residency type 143, the property type 144 and documentation type 146, then selects the search button 147. The search will return all lender programs the match the borrower's requirements as entered by the broker. The geographic location is selectable by the broker to be, for example, the location of the property, the residence of the borrower or the location of the broker, thereby finding lenders with representatives local to the property, borrower or broker, respectively.

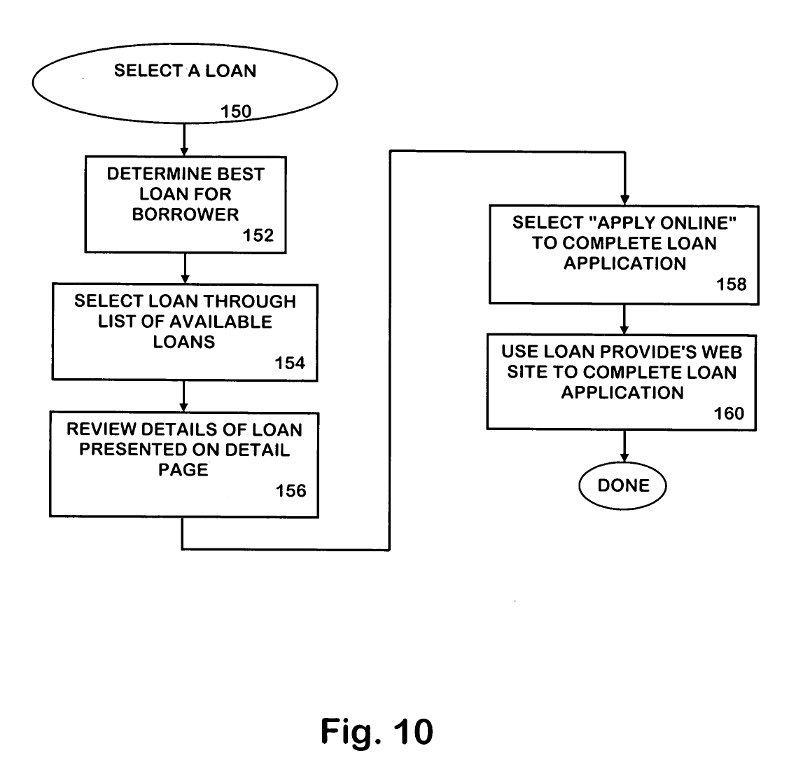

Referring to FIG. 10, a flow chart for the broker to complete the loan process for the borrower of the first embodiment of the present invention is shown. The broker selects a loan program from the results of the search 150 (FIG. 9). First, the broker reviews the list of loan programs 152 returned from the search (FIG. 9), determining a best fit for the borrower. The best loan is selected 154 and details are presented. The broker reviews the details 156 and, if right for the borrower, selects the “Apply Online” button 158, at which time the broker is redirected to the lender's web site where they can complete a loan application for the selected loan program 160.

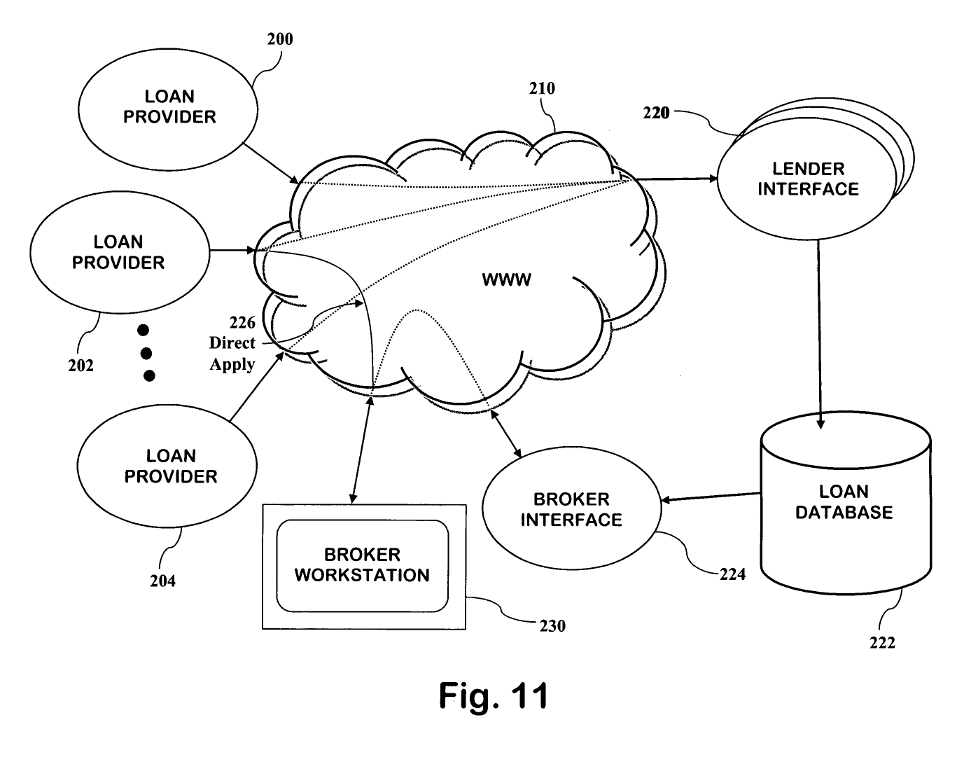

Referring to FIG. 11, a data connection diagram the first embodiment of the present invention is shown. One or more loan providers 200/202/204 access the loan brokering system of the present invention through a network such as the World Wide Web 210. The lenders are provided with a lender interface 220 for gathering information regarding the lenders and the loan programs available from the lenders and storing such in a loan database 222. One or more brokers access the loan brokering system from a broker workstation 230 connected to a broker interface 224 through the network 210. The broker interface 224 provides the loan program search function, accessing the loan programs stored in the loan database 222. Additionally, when the “Direct Apply” feature is activated, the broker workstation 230 is redirected to the associated loan provider through the network 210 as depicted by connection 226.

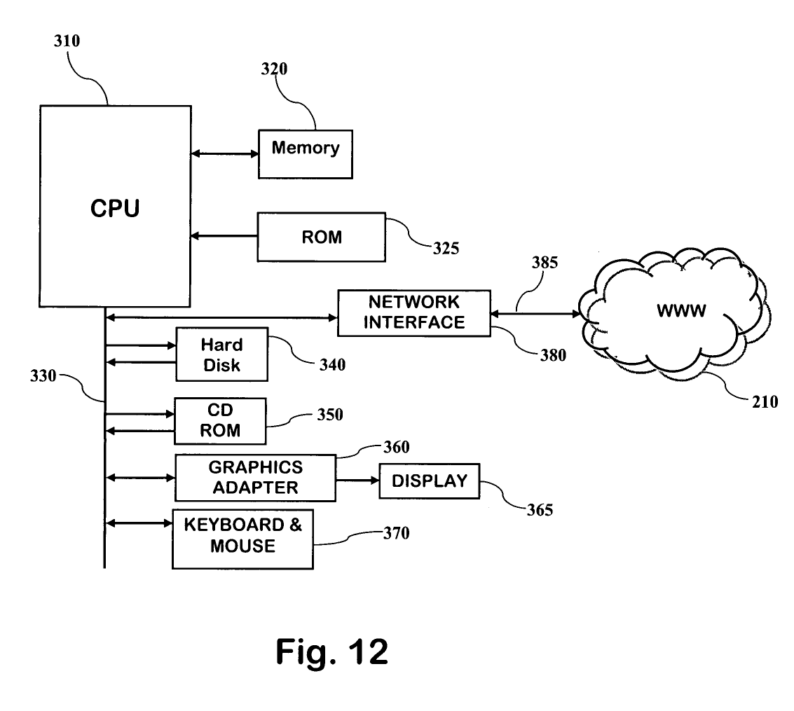

Referring to FIG. 12, a typical computer system the first embodiment of the present invention is shown. Although shown in its simplest form, having a single processor, many different computer architectures are known that accomplish similar results in a similar fashion and the present invention is not limited in any way to any particular computer system. The present invention works well utilizing a single processor system as shown in FIG. 12, a multiple processor system where multiple processors share resources such as memory and storage, a multiple server system where several independent servers operate in parallel (perhaps having shared access to the loan database 222) or any combination. In this, a processor 310 is provided to execute stored programs that are generally stored for execution within a memory 320. The processor 310 can be any processor or a group of processors, for example an Intel Pentium-4® CPU or the like. The memory 320 is connected to the processor and can be any memory suitable for connection with the selected processor 310, such as SRAM, DRAM, SDRAM, RDRAM, DDR, DDR-2, etc. Firmware is stored in firmware storage 325 that is connected to the processor 310 and may include initialization software known as BIOS. This initialization software usually operates when power is applied to the system or when the system is reset. In some embodiments, the software is read and executed directly from the firmware storage 325. Alternately, the initialization software is copied into the memory 320 and executed from the memory 320 to improve performance.

Also connected to the processor 310 is a system bus 330 for connecting to peripheral subsystems such as a network interface 380, a hard disk 340, a CDROM 350, a graphics adapter 360 and a keyboard/mouse 370. The graphics adapter 360 receives commands and display information from the system bus 330 and generates a display image that is displayed on the display 365.

In general, the hard disk 340 may be used to store programs, executable code and data persistently, while the CDROM 350 may be used to load said programs, executable code and data from removable media onto the hard disk 340. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 330 or with other input-output connections. Examples of these devices include printers; mice; graphics tablets; joysticks; and communications adapters such as modems and Ethernet adapters.

The network interface 380 connects the computer-based system to the world-wide-web 210 through a link 385 which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A loan brokering system for providing loan program information to brokers, the system comprising:
a server computer having a processor, a memory and a network interface, the network interface operatively coupling the server computer to a network;
a loan database operatively coupled to the server computer;
a lender interface operating on the server computer for accepting the loan program information and storing the loan program information in the loan database; and
a broker interface operating on the server computer, the broker interface adapted to input borrower information, adapted to search the loan database for loan programs matching the borrower information and adapted to display the loan programs matching the borrower information.

2. The loan brokering system of claim 1, wherein the broker interface further comprises a direct apply function adapted to connect the broker interface directly to a lender web site through the network.

3. The loan brokering system of claim 2, wherein the broker has a user account and a password for accessing the lender web site.

4. The loan brokering system of claim 1, wherein at least one lender accesses the loan brokering system and the at least one lender inputs the loan program information through the lender user interface.

5. The loan brokering system of claim 1, wherein the loan program information includes a program name, a name of the lender's representative, a geographic location, a minimum credit score, a minimum loan amount, a maximum loan amount, a maximum cash-out, a number of trade lines, a maximum loan-to-value, a maximum debt ratio and a number of bankruptcies.

6. The loan brokering system of claim 5, wherein the loan program information further includes an occupancy type, a loan type, loan type details, a loan purpose, a lien type, a residency type, a property type and a documentation type.

7. A method for providing loan program information to loan brokers, the method comprising:
inputting loan program information for at least one loan program;
storing the loan program information into a loan database;
obtaining a borrower's loan criteria from a broker;
searching the loan database for at least one loan program matching the borrower's loan criteria;
selecting a qualified loan from the at least one loan program matching the borrower's loan criteria; and
presenting the qualified loan to the borrower.

8. The method of claim 7, further comprising using a direct-apply web address to access a lender web site and directly applying for a loan.

9. The method of claim 8, wherein the broker has a user account and a password for accessing the lender web site.

10. The method of claim 7, wherein the inputting is done by a lender.

11. The method of claim 7, wherein the loan program information includes a program name, a name of the lender's representative, a minimum credit score, a minimum loan amount, a maximum loan amount, a maximum cash-out, a number of trade lines, a maximum loan-to-value, a maximum debt ratio and a number of bankruptcies.

12. The method of claim 11, wherein the loan program information further includes an occupancy type, a loan type, loan type details, a loan purpose, a lien type, a residency type, a property type and a documentation type.

13. The method of claim 7, wherein the borrower's loan criteria includes a loan amount, a borrower's middle credit score, a property value and a geographic location.

14. The method of claim 13, wherein the borrower's loan criteria further includes an occupancy type, a loan type, a loan purpose, a residency type, a property type and a documentation type.

15. The method of claim 13, wherein the geographic location is selected from the group consisting of a lender's location, a borrower's location and a property location.

16. A computer based method for providing loan program information to loan brokers, the method comprising:
presenting a user interface for inputting loan program information for at least one loan program;
storing the loan program information into a loan database;
presenting a second user interface for obtaining a borrower's loan criteria from a broker;
searching the loan database for at least one loan program matching the borrower's loan criteria; and
presenting a summary user interface for selecting a qualified loan from the at least one loan program matching the borrower's loan.

17. The method of claim 16, further comprising presenting a direct-apply function to allow broker access to a lender web site and to allow directly applying for a loan.

18. The method of claim 17, wherein the broker has a user account and a password for accessing the lender web site.

19. The method of claim 16, wherein the inputting is done by a lender.

20. The method of claim 16, wherein the loan program information includes a program name, a name of the lender's representative, a geographic location, a minimum credit score, a minimum loan amount, a maximum loan amount, a maximum cash-out, a number of trade lines, a maximum loan-to-value, a maximum debt ratio and a number of bankruptcies.

21. The method of claim 20, wherein the loan program information further includes an occupancy type, a loan type, loan type details, a loan purpose, a lien type, a residency type, a property type and a documentation type.

22. The method of claim 16, wherein the borrower's loan criteria includes a loan amount, a borrower's middle credit score, a property value and a geographic location.

23. The method of claim 22, wherein the borrower's loan criteria further includes an occupancy type, a loan type, a loan purpose, a residency type, a property type and a documentation type.

24. A computer readable medium including computer programming instructions that cause a computer to perform the method for providing loan program information to loan brokers, the method comprising:
presenting a user interface for inputting loan program information for at least one loan program;
storing the loan program information into a loan database;
presenting a second user interface for obtaining a borrower's loan criteria from a broker;
searching the loan database for at least one loan program matching the borrower's loan criteria; and
presenting a summary user interface for selecting a qualified loan from the at least one loan program matching the borrower's loan criteria.

25. The computer readable medium including computer programming instructions that cause a computer to perform the method for providing loan program information to loan brokers of claim 24, further comprising the method of presenting a direct-apply function to allow the broker to access a lender web site and to allow directly applying for a loan.

26. The computer readable medium including computer programming instructions that cause a computer to perform the method for providing loan program information to loan brokers of claim 24, wherein the inputting is done by a lender.

27. The computer readable medium including computer programming instructions that cause a computer to perform the method for providing loan program information to loan brokers of claim 24, wherein the loan program information includes a program name, a name of the lender's representative, a minimum credit score, a minimum loan amount, a maximum loan amount, a maximum cash-out, a number of trade lines, a maximum loan-to-value, a maximum debt ratio and a number of bankruptcies.

28. The computer readable medium including computer programming instructions that cause a computer to perform the method for providing loan program information to loan brokers of claim 27, wherein the loan program information further includes an occupancy type, a loan type, loan type details, a loan purpose, a lien type, a residency type, a property type and a documentation type.

29. The computer readable medium including computer programming instructions that cause a computer to perform the method for providing loan program information to loan brokers of claim 24, wherein the borrower's loan criteria includes a loan amount, a borrower's middle credit score, a property value and a geographic location.

30. The computer readable medium including computer programming instructions that cause a computer to perform the method for providing loan program information to loan brokers of claim 29, wherein the borrower's loan criteria further includes an occupancy type, a loan type, a loan purpose, a residency type, a property type and a documentation type.

31. A computer program product for use with a computer system for providing loan program information to loan brokers, the computer program product comprising:
a computer usable medium having computer-readable code means embodied in the medium, the computer-readable code means comprising:
a plurality of computer readable code means for presenting a user interface for inputting loan program information for at least one loan program;
a plurality of computer readable code means for storing the loan program information into a loan database;
a plurality of computer readable code means for presenting a second user interface for obtaining borrower's a loan criteria from a broker;
a plurality of computer readable code means for searching the loan database for at least one loan program matching the borrower's loan criteria; and
a plurality of computer readable code means for presenting a summary user interface for selecting a qualified loan from the at least one loan program matching the borrower's loan criteria.

32. The computer program product for use with a computer system for providing loan program information to loan brokers of claim 31, further comprising the method of presenting a direct-apply function to allow the broker to access a lender web site and to allow directly applying for a loan.

33. The computer program product for use with a computer system for providing loan program information to loan brokers of claim 31, wherein the inputting is done by a lender.

34. The computer program product for use with a computer system for providing loan program information to loan brokers of claim 31, wherein the loan program information includes a program name, a name of the lender's representative, a minimum credit score, a minimum loan amount, a maximum loan amount, a maximum cash-out, a number of trade lines, a maximum loan-to-value, a maximum debt ratio and a number of bankruptcies.

35. The computer program product for use with a computer system for providing loan program information to loan brokers of claim 34, wherein the loan program information further includes an occupancy type, a loan type, loan type details, a loan purpose, a lien type, a residency type, a property type and a documentation type.

36. The computer program product for use with a computer system for providing loan program information to loan brokers of claim 31, wherein the borrower's criteria includes a loan amount, a borrower's middle credit score, a property value and a geographic location.

37. The computer program product for use with a computer system for providing loan program information to loan brokers of claim 36, wherein the borrower's criteria further includes an occupancy type, a loan type, a loan purpose, a residency type, a property type and a documentation type.
